(19) United States
(12) Patent Application Publication
(10) Pub. No.: US 2020/0067379 A1
(43) Pub. Date: Feb. 27, 2020

(54) Actuating Motor For an Electric Camshaft Adjustment

(71) Applicant: Schaeffler Technologies AG & Co. KG, Herzogenaurach (DE)

(72) Inventors: Jens Hoppe, Erlangen (DE); Christian Greuel, Nürnberg (DE)

(73) Assignee: Schaeffler Technologies AG & Co. KG, Herzogenaurach (DE)

(21) Appl. No.: 16/488,697

(22) PCT Filed: Mar. 15, 2018
(86) PCT No.: PCT/DE2018/100232

§ 371 Date: Aug. 26, 2019

(30) Foreign Application Priority Data
Mar. 15, 2017 (DE) 10 2017 105 455.3

(51) Int. Cl. H02K 7/08; H02K 7/116; F01L 1/02; H02K 5/22

(52) U.S. Cl. CPC H02K 7/08; H02K 5/225; F01L 1/02; H02K 7/116

(57) ABSTRACT

The disclosure relates to an electric motor, in particular an actuating motor for an electric camshaft adjuster. The electric motor includes a cup-shaped housing, a stator module which closes the housing and to which electric contact elements are secured, and a driven shaft. The driven shaft protrudes out of the housing, is guided in the housing and the stator module by means of rolling bearings, and is connected to a drive element. The electric motor together with the housing part defines a ventilated area of the internal combustion engine, and the rolling bearing facing the drive element has a cover/sealing disc at least facing the drive element.

### CROSS-REFERENCE TO RELATED APPLICATIONS

This application is the U.S. National Phase of PCT Application No. PCT/DE2018/100232 filed on Mar. 15, 2018 which claims priority to DE 10 2017 105 455.3 filed on Mar. 15, 2017, the entire disclosures of which are incorporated by reference herein.

### TECHNICAL FIELD

This disclosure relates to an electric motor, in particular an actuating motor for an electric camshaft adjuster. The electric motor includes a cup-shaped housing, a stator module which closes off the housing and to which electric contact elements are fastened, and a driven shaft. The driven shaft protrudes out of the housing, is guided by means of anti-friction bearings in the housing and the stator module, and is connected to a drive element.

### BACKGROUND

An electric motor of this type as an actuating motor for an electric camshaft adjusting means is known from DE 10 2013 212 933. Said actuating motor is connected to a housing of an internal combustion engine, which housing conducts oil or oil mist. The outer anti-friction bearing which faces the drive element is of open configuration, with the result that it is lubricated by the oil. In order to prevent the penetration of oil into the electric motor, a sealing element is inserted following said anti-friction bearing between the housing and the shaft. The outer wall of the housing is likewise surrounded by oil mist.

### SUMMARY

It is an object of the disclosure to modify an electric motor which is configured as an actuating motor for an electric camshaft adjusting means, in such a way that said electric motor can be operated outside oil-wetted spaces.

According to the disclosure, the object is achieved by virtue of the fact that the anti-friction bearing which faces the drive element has a cover/sealing disk at least toward the drive element. As a result, it is possible to configure the bearing as a self-lubricating bearing. It is therefore independent of an external oil or oil mist supply. The anti-friction bearing is arranged in a sealing manner in the housing and on the shaft, with the result that the sealing element behind the anti-friction bearing between the shaft and the housing can be dispensed with.

Furthermore, it is proposed that the surface of the housing which faces the oil-free space, the surface of the drive element and partially that of the shaft are provided with an anti-corrosion coating, in order to avoid the accumulation of rust, for example. The coating can comprise zinc/nickel, hard chrome, PTFE, TRIONDUR or the like. In order to fasten the electric motor to the housing of the internal combustion engine, a fastening flange is arranged on the housing and/or the stator module.

### BRIEF DESCRIPTION OF THE DRAWINGS

The disclosure is described in the drawings:

FIG. 1 shows a perspective view of an actuating motor, and

FIG. 2 shows a side view with a partial section through the outer bearing and shaft region.

### DETAILED DESCRIPTION

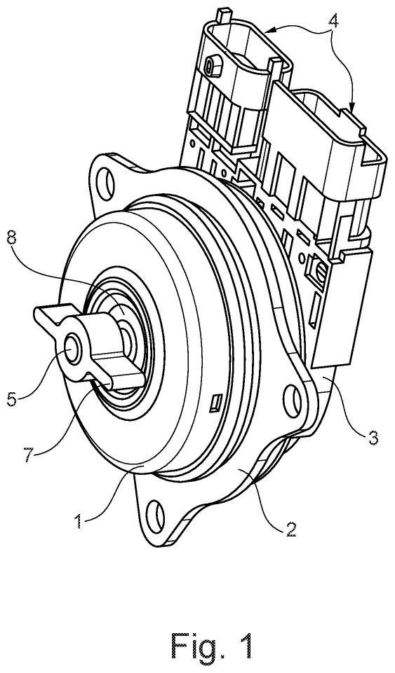

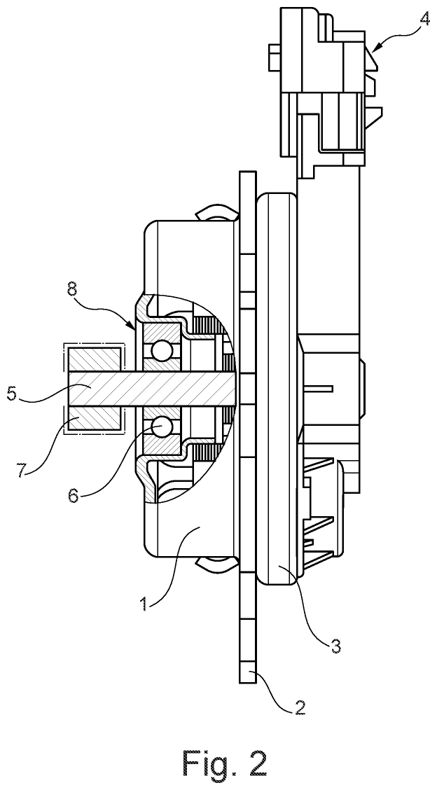

In FIGS. 1 and 2, insofar as it is shown in detail, 1 denotes a cup-shaped housing which is adjoined by a fastening flange 2 which merges into a stator module 3, to which electric contact elements 4 are connected. A shaft 5 which is driven by the electric motor unit is mounted in the housing 1 and the stator module 3. An anti-friction bearing 6 is installed between the shaft 5 and the cup-shaped housing 1, which anti-friction bearing 6 is arranged in a sealing manner on the shaft and in the housing. A drive element 7 is fastened on the shaft 5, which drive element 7 is operatively connected (not shown) to the camshaft adjusting means. The anti-friction bearing 6 has a cover/sealing disk 8 at least on the side which faces the drive element 7, with the result that the anti-friction bearing 6 can be of self-lubricating configuration.

### LIST OF REFERENCE CHARACTERS

1 Cup-shaped housing
2 Fastening flange
3 Stator module
4 Electric contact elements
5 Shaft
6 Anti-friction bearing
7 Drive element
8 Cover/sealing disk

1. An electric motor for an electric camshaft adjuster, comprising:
a cup-shaped housing,
a stator module which closes off the housing and to which electric contact elements are fastened,
a driven shaft guided in the housing and the stator module by an anti-friction bearing, the driven shaft protruding out of the housing and connected to a drive element, and
the electric motor defines, with the housing, a ventilated space of an internal combustion engine, and the anti-friction bearing which faces the drive element has a cover on a side of the anti-friction bearing toward the drive element.

2. The electric motor as claimed in claim 1, wherein surfaces of the housing, of the drive element and partially of the shaft which are part of an oil-free space are provided with an anti-corrosion coating.

3. The electric motor as claimed in claim 1, wherein the coating comprises at least one of zinc, nickel, hard chrome, PTFE, or TRIONDUR.

4. An electric motor for an electric camshaft adjuster, comprising:
a housing,
a stator module including electric contact elements, the stator module closing off the housing, and
a driven shaft guided in the housing by an anti-friction bearing, the driven shaft protruding out of the housing and connected to a drive element configured to be operatively connected to a camshaft adjuster, and
the housing defining a ventilated space configured for an internal combustion engine, and the anti-friction bearing having a cover on a side of the anti-friction bearing toward the drive element.

5. The electric motor as claimed in claim 4, wherein the ventilated space is free of an oil mist or external oil supply.

6. The electric motor as claimed in claim 4, wherein at least one of the housing, the drive element, or the driven shaft are provided with an anti-corrosion coating.

7. An electric motor for an electric camshaft adjuster, comprising:
a housing,
a stator module including electric contact elements, the stator module closing off the housing, and
a driven shaft guided in the housing by a self-lubricating anti-friction bearing, the driven shaft protruding out of the housing and connected to a drive element configured to be operatively connected to a camshaft adjuster.

8. The electric motor of claim 7, wherein the self-lubricating anti-friction bearing is configured to seal with the driven shaft and the housing.

9. The electric motor of claim 8, wherein at least one axial side of the self-lubricating anti-friction bearing includes a sealing disk.

10. The electric motor of claim 8, wherein the self-lubricating anti-friction bearing provides an only seal for the driven shaft within the electric motor.

11. The electric motor of claim 7, wherein a space defined by the driven shaft, the drive element, and a side of the self-lubricating anti-friction bearing that faces the drive element, is free of an oil mist or an oil supply.

12. The electric motor of claim 7, wherein at least one of the housing, the drive element, or the driven shaft are provided with an anti-corrosion coating.

13. The electric motor of claim 12, wherein the anti-corrosion coating is a TRIONDUR coating.

14. The electric motor of claim 13, wherein the anti-corrosion coating is an amorphous carbon coating.

15. The electric motor of claim 13, wherein the anti-corrosion coating is a titanium nitride coating.
